(19) United States
(12) Patent Application Publication
(10) Pub. No.: US 2009/0132198 A1
(43) Pub. Date: May 21, 2009

(54) Mobile Electronic Apparatus and Method for Processing Bearing of Mobile Electronic Apparatus

(75) Inventors: Kazuto Ito, Kanagawa (JP); Yasuhiro Ueno, Kanagawa (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/280,972

(22) PCT Filed: Feb. 14, 2007
(86) PCT No.: PCT/JP2007/052587

§ 371 Date: Dec. 10, 2008

(30) Foreign Application Priority Data
Feb. 27, 2006 (JP) 2006-051377

(51) Int. Cl. G01C 17/00; G06F 15/00; G08B 21/00

(52) U.S. Cl. 702/150; 33/356; 340/540

(57) ABSTRACT

The influence of a magnetic field on a geomagnetic sensor is detected to report a highly reliable bearing, and a 3D geomagnetic sensor (170A) is arranged at a position facing a magnet (190). An external magnetic field detection processing unit (160) detects the approach of the magnet (190) to the 3D geomagnetic sensor (170A), and uses the unit for detecting opening and closing of the housing. In addition, the unit judges whether there is influence by an external magnetic field according to whether the effect of the magnetic field of the magnet (190) is being felt and reflects this in the report of the bearing information.

### TECHNICAL FIELD

The present invention relates to, for example, a mobile phone, mobile terminal, or other mobile electronic apparatus providing a geomagnetic (geomagnetism) sensor in a housing and using that geomagnetic sensor to detect a bearing and a method for processing a bearing (an azimuth) in a mobile electronic apparatus.

### BACKGROUND ART

The technology of providing a geomagnetic sensor in a mobile phone or other mobile electronic apparatus and reporting the bearing of the mobile electronic apparatus from a detected signal of the geomagnetic sensor while reporting position information of GPSs etc. is already known.

When a geomagnetic sensor is influenced by an external magnetic field, the bearing calculated based on the signal detected by the geomagnetic sensor becomes wrong. For this reason, various technologies for eliminating or reducing the influence of the external magnetic field on a geomagnetic sensor have been proposed.

Patent Document 1 discloses technology of reporting the bearing of a mobile electronic apparatus from the detected signal of a geomagnetic sensor and, when reporting GPS or other positional information, controlling the report of the bearing information in a place where the influence of an external magnetic field is large.

Patent Document 1: Japanese Patent Publication (A) No. 2005-300896

### DISCLOSURE OF THE INVENTION

### Problems to be Solved by the Invention

The technology disclosed in Patent Document 1 performs processing with respect to an external magnetic field only when the influence of the external magnetic field is large. When, for example, there is a magnet around the geomagnetic sensor, it cannot judge the location of that magnet. Therefore, it cannot judge whether the influence is exerted by an external magnetic field. As a result, there is a possibility of reporting erroneous bearing information.

Further, it could not detect the magnitude of the surrounding external magnetic field.

From the above, it has been desired to provide a mobile electronic apparatus detecting the influence of an external magnetic field on a geomagnetic sensor and suitably processing the bearing according to the situation and a method for processing a bearing of a mobile electronic apparatus.

### Means for Solving the Problem

According to the present invention, there is provided a mobile electronic apparatus including: a housing; a geomagnetic sensor provided in the housing and detecting geomagnetism; a bearing calculation unit configured to calculate a geographical bearing based on a detected value of the geomagnetic sensor; a bearing information report unit configured to report bearing information based on the bearing calculated by the bearing calculation unit; an external magnetism detection unit configured to detect an external magnetism with respect to the geomagnetic sensor; and a report suppression unit configured to suppress the report of bearing information by the bearing information report unit when the detected value of the external magnetism by the external magnetism detection unit becomes a predetermined value or greater.

Further, according to the present invention, there is provided a method for processing a bearing of a mobile electronic apparatus having a housing and a geomagnetic sensor provided in the housing and detecting geomagnetism, the method including: a bearing calculation step of calculating a geographical bearing based on the detected value of the geomagnetic sensor; a bearing information reporting step of reporting information based on the bearing calculated at the bearing calculation step; an external magnetism detection step of detecting an external magnetism with respect to the geomagnetic sensor; and a report suppression step of suppressing the report of bearing information in the bearing information reporting step when the value detected in the external magnetism detection step becomes a predetermined value or greater.

### EFFECT OF THE INVENTION

According to the present invention, the influence of an external magnetic field etc. with respect to a geomagnetic sensor is detected by using a suitable method and components in a mobile electronic apparatus. Therefore, it is possible to report or suppress bearing information considering that influence and avoid report of erroneous bearing information.

Alternatively, according to the present invention, a user can be made recognize that a geomagnetic sensor is being influenced by an external magnetic field etc.

### BRIEF DESCRIPTION OF THE DRAWINGS

FIGS. 1(A) and 1(B) are an external perspective view and an external cross-sectional view of a flip-open type mobile phone of the present embodiment.

FIG. 2 is a diagram illustrating a portion of the components mainly showing a signal processing unit in a mobile phone mounted (arranged) in a first housing and a second housing illustrated in FIG. 1.

FIGS. 3(A) and 3(B) are diagrams showing a first example of arrangement of a geomagnetic sensor, a magnetic sensor, and a magnet.

FIGS. 4(A) and 4(B) are diagrams showing a second example of arrangement of a geomagnetic sensor, a magnetic sensor, and a magnet.

FIG. 5 is a diagram showing a threshold value (or judgment level) used for judgment processing based on a geomagnetism detected value of the geomagnetic sensor.

FIG. 6 is a flow chart showing first processing of the signal processing unit illustrated in FIG. 1.

FIGS. 7(A) and 7(B) are diagrams illustrating a third example of arrangement of a geomagnetic sensor, a magnetic sensor, and a magnet.

FIG. 8 is a flow chart showing second processing of the signal processing unit illustrated in FIG. 1.

FIGS. 9(A) and 9(B) are diagrams illustrating a fourth example of arrangement of a geomagnetic sensor, a magnetic sensor, and a magnet.

FIG. 10 is a view of the outer appearance of a straight type mobile phone of a first example of a second embodiment of the mobile electronic apparatus of the present invention.

FIG. 11 is a view of the outer appearance of a straight type mobile phone of a second example of a second embodiment of the mobile electronic apparatus of the present invention.

### DESCRIPTION OF NOTATIONS

1 . . . flip-open type mobile phone
1A . . . straight type mobile phone
3 . . . first housing, 3a . . . first housing upper portion, 3b first housing lower portion, 3c . . . first housing seam
4 . . . second housing, 4a second housing upper portion, 4b . . . second housing lower portion, 4c second housing seam
5 . . . connecting portion
10, 10A . . . key input units, 12, 12A . . . display units
100 . . . mobile electronic apparatus's electronic circuit unit
101 . . . wireless communication unit, 102 . . . GPS signal receiving unit
104 . . . audio processing unit, 105 . . . speaker, 106 . . . microphone
109 . . . storage unit, 110 . . . power source switch unit, 111 . . . battery unit
121 . . . wireless communication use antenna, 122 . . . GPS use antenna
150 . . . signal processing unit
152 . . . general processing unit, 154 . . . bearing calculation unit, 156 . . . bearing information report unit,
158 . . . report suppression unit, 160 . . . external magnetism detection processing unit
170 . . . two-dimensional geomagnetic sensor, 170A . . . three-dimensional geomagnetic sensor
180 . . . magnetic sensor, 190 . . . magnet

### BEST MODE FOR CARRYING OUT THE INVENTION

### First Embodiment

Below, a flip-open type mobile phone will be illustrated as a first embodiment of a mobile electronic apparatus of the present invention.

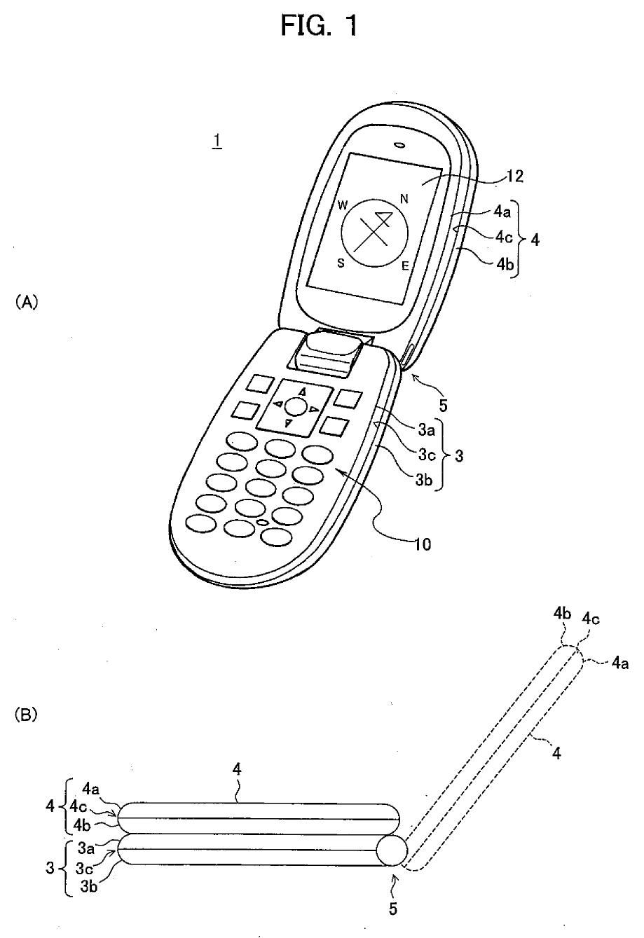

FIGS. 1(A) and 1(B) are an external perspective view of a flip-open type mobile phone of the present embodiment and an external cross-sectional view of a mobile phone 1.

The flip-open type mobile phone 1 has a first housing 3, a second housing 4, and a connecting portion 5. The first housing 3 and second housing 4 are configured to freely open and close so that the first housing 3 and second housing 4 can pivot about the connecting portion 5 to take a facing state illustrated by the solid lines of FIG. 1(B) or a spaced state illustrated by the broken lines of FIG. 1(B).

The first housing 3 corresponds to the first housing of the present invention, the second housing 4 corresponds to the second housing of the present invention, and the connecting portion 5 corresponds to the connecting means of the present invention.

The facing state (approaching state) of the first housing 3 and second housing 4 illustrated by the solid lines of FIG. 1(B) will be called, for example, the “first state of the housings” in the present invention, while the state where the first housing 3 and second housing 4 are spaced apart to a certain extent as illustrated by the broken lines of FIG. 1(B) will be called, for example, the “second state of the housings” in the present invention. In other words, the first state of the housings means, as will be explained in detail later, for example, a state where the geomagnetic sensor arranged in the first housing 3 is influenced by a magnetic field of a magnet etc. arranged in the second housing 4. On the other hand, the second state of housings means, as will be explained in detail later, for example, a state where the first housing 3 and second housing 4 are spaced apart to a state where the geomagnetic sensor arranged in the first housing 3 is not influenced much by the magnetic field of the magnet etc. arranged in the second housing 4.

The first housing 3 has a first housing upper portion 3a and a first housing lower portion 3b divided by a first housing seam 3c. Naturally, the first housing upper portion 3a and the first housing lower portion 3b are connected to integrally form the first housing 3.

The second housing 4 also has a second housing upper portion 4a and a second housing lower portion 4b divided by a second housing seam 4c. Naturally, the second housing upper portion 4a and the second housing lower portion 4b are connected to integrally form the second housing 4.

On the surface of the first housing upper portion 3a, a key input unit 10 having ten-key switches, function selection buttons, etc. is arranged. In the second housing upper portion 4a, a liquid crystal display or other display unit 12 is arranged.

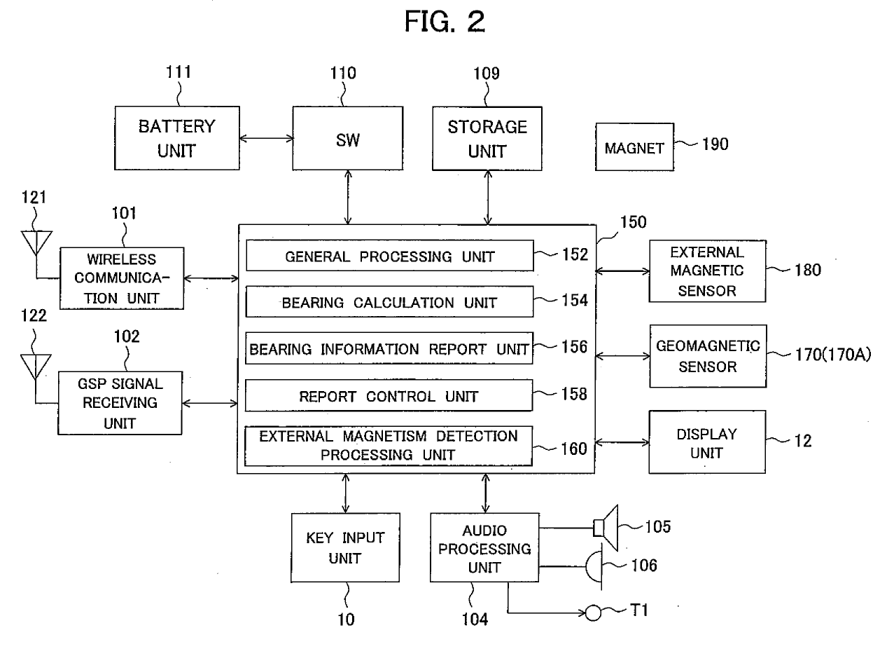

FIG. 2 is a diagram illustrating a portion of the components mainly showing a signal processing unit 100 in a flip-open type mobile phone 1 mounted (arranged) in the first housing 3 and second housing 4.

For example, in the first housing lower portion 3b, a wireless communication unit 101, GPS signal receiving unit 102, audio processing unit 104, storage unit 109, power switch unit 110, battery unit 111, and signal processing unit 150 are arranged (mounted). For example, in the first housing upper portion 3a, other than the ten-key input unit 10, a speaker 105 connected to the audio processing unit 104, and a microphone 106 are arranged. A wireless communication use antenna 121 connected to the wireless communication unit 101 and a GPS use antenna 122 connected to the GPS signal receiving unit 102 are arranged at suitable locations such as the first housing lower portion 3b or the second housing lower portion 4b.

The signal processing unit 150 is configured by using, for example, a microprocessor (pP) and has general processing unit 152, bearing calculation unit 154, bearing information report unit 156, report suppression unit 158, and external magnetism detection processing unit 160.

Note that, in the present embodiment, the general processing unit 152, bearing calculation unit 154, bearing information report unit 156, report suppression unit 158, and external magnetism detection processing unit 160 are realized by a program stored in the storage unit 109 and conducting processing explained below in a central processing unit (CPU) in the signal processing unit 150.

The storage unit 109 has, for example, a ROM storing a program performing the processing explained above and fixed parameters etc. and a RAM used for temporary storage and processing of various types of data.

The processing content of the signal processing unit 150 will be explained in brief next.

The general processing unit 152 performs, for example, the following processing based on, for example, an operation instruction of the user from the key input unit 10.

(1) Voice Processing

When the user dials a number via the key input unit 10, the general processing unit 152 detects that and performs voice processing with the calling side via the audio processing unit 104, wireless communication unit 101, and wireless communication antenna 121. For example, the audio processing unit 104 processes an audio signal input from the microphone 106 and transmits the result via the wireless communication unit 101 to the other party. At the same time, the unit outputs an audio signal of the other party via the speaker 105.

The general processing unit 152 manages the above processing and displays information concerned with the speech in the display unit 12 according to need.

(2) Position Display Processing

When the user requests display of the position via the key input unit 10, the general processing unit 152 detects that, obtains the position information of the mobile phone 1 via the GPS signal receiving unit 102 and GPS use antenna 122, and displays a result of that as a graphic in, for example, the display unit 12.

(3) Other Processing

The general processing unit 152, other than that, for example, manages the residual life of the battery unit 111.

Further, the general processing unit 152 performs the processing explained below in cooperation with the bearing calculation unit 154, bearing information report unit 156, report suppression unit 158, and/or, external magnetism detection processing unit 160.

### First Example of Arrangement of Geomagnetic Sensor, Magnetic Sensor, and Magnet

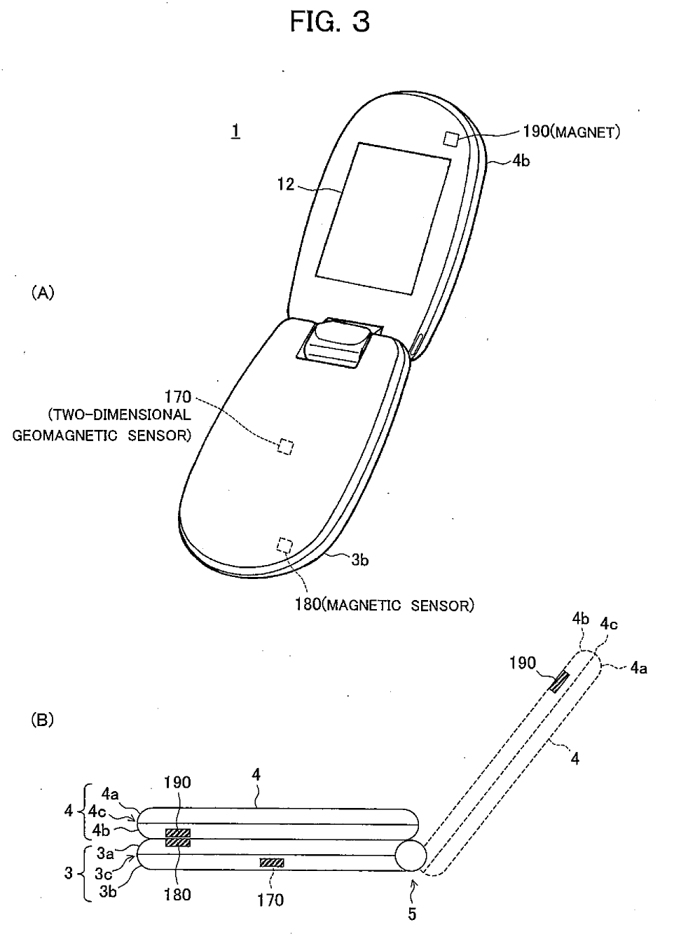

FIGS. 3(A) and 3(B) are diagrams corresponding to FIGS. 1(A) and 1(B) and illustrate a first example of arrangement of a two-dimensional geomagnetic sensor 170, a magnetic sensor 180, and a magnet 190.

For simplifying the illustration, only the two-dimensional geomagnetic sensor 170, magnetic sensor 180, and magnet 190 are illustrated.

The two-dimensional geomagnetic sensor 170 is a sensor detecting geomagnetism in a two-dimensional direction, that is, a planar direction, and the magnet 190 is a permanent magnet.

Detection of Open/Closed State of First Housing and Second Housing

The magnetic sensor 180 arranged on a back surface or front surface of the first housing upper portion 3a and the magnet 190 arranged at an outer circumferential portion of the display unit 12 on the back surface or front surface of the second housing lower portion 4b are located at positions where they face each other when the first housing 3 and second housing 4 face each other.

When the first housing 3 and second housing 4 face each other, the magnetic sensor 180 and the magnet 190 substantially face each other, and the magnetic sensor 180 is affected by the strong magnetic field of the magnet 190. When the magnetic field of the magnet 190 detected by the magnetic sensor 180 exceeds a predetermined level, the general processing unit 152 detects that the first housing 3 and the second housing 4 are in the facing state or substantial facing state. This state will be called the “first state of the housings”.

On the other hand, when the first housing 3 and the second housing 4 are spaced apart, the influence of the magnetic field of the magnet 190 on the magnetic sensor 180 is lowered. When the magnetic field of the magnet 190 detected by the magnetic sensor 180 becomes a predetermined level or less, the general processing unit 152 detects that the first housing 3 and the second housing 4 are in the second state where these are spaced apart. This state will be called the “second state of the housings”.

In this way, the magnetic sensor 180 and the magnet 190 can be used for detecting the open/closed state of the first housing 3 and the second housing 4.

The two-dimensional geomagnetic sensor 170 is arranged at the substantial center of the first housing lower portion 3b. The reason for that is for preventing the first housing 3 and the second housing 4 from being influenced by the magnetic field of the magnet 190 as much as possible even when these face each other. Namely, the two-dimensional geomagnetic sensor 180 is sensitive to even a very small magnetic field, therefore the reason is for avoiding the bearing becoming off due to the magnet 190.

In this arrangement, the bearing calculation unit 154 calculates the bearing based on the detected value of the two-dimensional geomagnetism detected by the two-dimensional geomagnetic sensor 170, while the bearing information report unit 156 reports (displays) the results of that on, for example, the display unit 12 as graphic information in cooperation with the general processing unit 152.

Giving a concrete example of the graphic information of the bearing, for example, as shown in FIG. 1, a graphic indicating north is displayed on the display unit 12. Other than displaying the bearing information in this way, the bearing information may be reported by operating a buzzer or emitting another sound when one end of the mobile phone 1 faces the north direction. Naturally, as the method of report of the bearing information, other various methods which can be recognized by the user can be employed.

The bearing calculation unit 154 corresponds to the bearing calculating means of the present invention. Note that, as the bearing calculation method in the bearing calculation unit 154, known methods can be used, so a detailed explanation is omitted.

The bearing information report unit 156 corresponds to the bearing information reporting means of the present invention.

In the arrangement of the two-dimensional geomagnetic sensor 170, magnetic sensor 180, and magnet 190 exemplified in FIGS. 3(A) and 3(B), the two-dimensional geomagnetic sensor 170 is resistant to influence by the magnet 190. However, the two-dimensional geomagnetic sensor 170 and the magnetic sensor 180 are spaced apart, therefore it is difficult to detect that when an external magnetic field other than the magnet 190 exerts an influence upon the two-dimensional geomagnetic sensor 170.

Accordingly, in this example, the report suppression unit 158 serving as the report suppressing means of the present invention and the external magnetism detection processing unit 160 serving as the external magnetism detecting means do not function.

Below, an example where the external magnetism detection processing unit 160 substantially functions in the report suppression unit 158 will be explained.

### Second Example of Arrangement of Geomagnetic Sensor and Magnet@

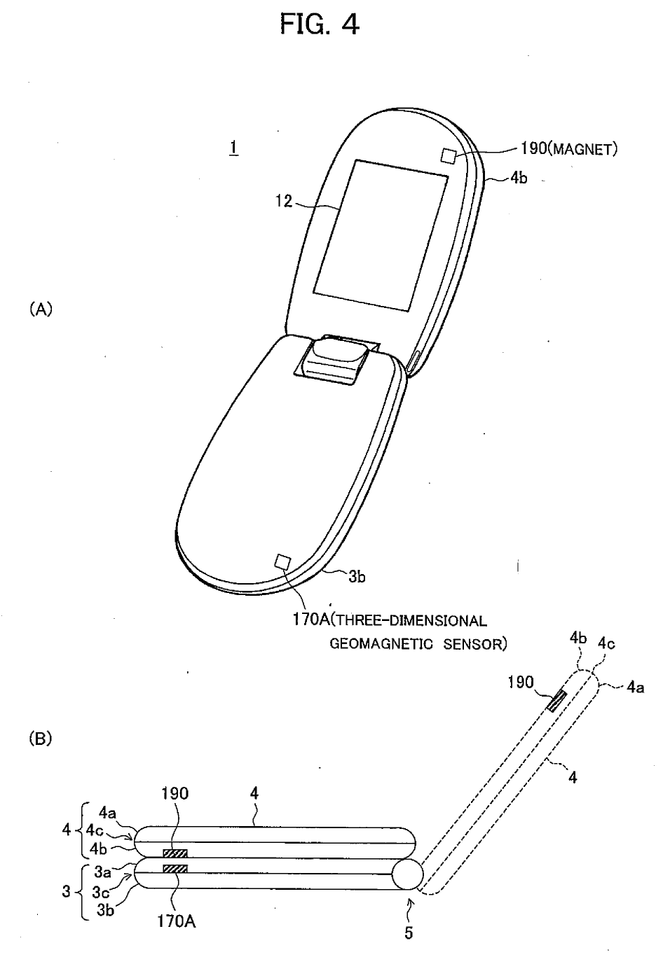

FIGS. 4(A) and 4(B) are diagrams corresponding to FIGS. 1(A) and 1(B) and illustrate a second example of arrangement of a three-dimensional geomagnetic sensor 170A and the magnet 190. Note, for simplifying the illustration, only the three-dimensional geomagnetic sensor 170A and magnet 190 are illustrated.

In this example of arrangement, the magnetic sensor 180 is not provided.

The three-dimensional geomagnetic sensor 170A arranged on the back surface or front surface of the first housing upper portion 3a and the magnet 190 arranged in an outer circumferential portion of the display unit 12 on the back surface or front surface of the second housing lower portion 4b are arranged at positions where these face each other when the first housing 3 and second housing 4 face each other.

In the present example, the three-dimensional geomagnetic sensor 170A is configured to be capable of detecting, other than the intensity of the geomagnetism in the two-dimensional direction, the intensity of magnetism from the magnet 190 and other magnetisms as well.

The magnet 190 is a permanent magnet.

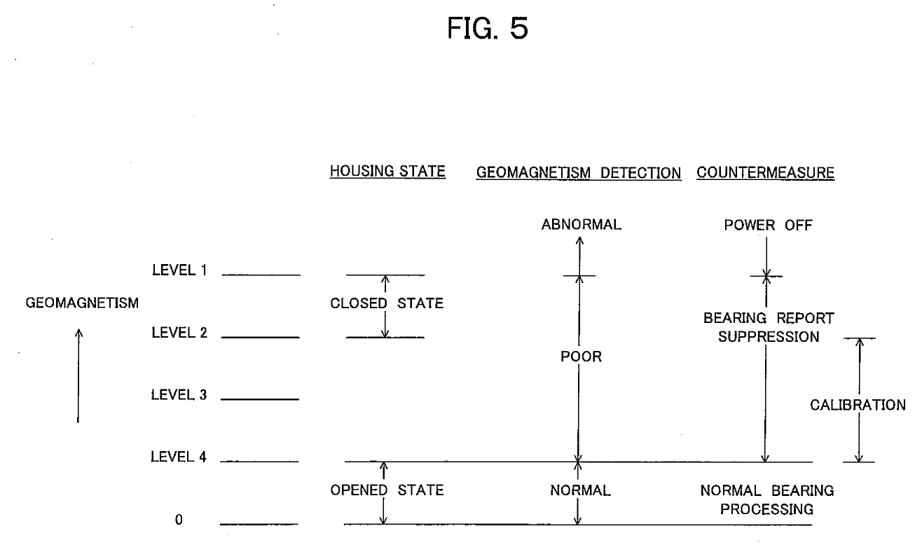

The judgment based on the detected value of the intensity of the magnetism of the three-dimensional geomagnetic sensor 170A will be explained with reference to the threshold value (or judgment level) for judgment of the state illustrated in FIG. 5.

(1) Fourth Level or Less (State of Housings Spaced Apart, Normal Geomagnetism Detected)

The three-dimensional geomagnetic sensor 170A strongly senses a magnetic field, therefore senses even very small magnetic fields. The three-dimensional geomagnetic sensor 170A of the present example can detect the intensity of the magnetism as well.

In the state where the first housing 3 and the second housing 4 are sufficiently spaced apart, the three-dimensional geomagnetic sensor 170A is not influenced by the strong magnetic field of the magnet 190.

Alternatively, when there is no influence of any external magnetic field other than the magnet 190, the geomagnetism detected value of the three-dimensional geomagnetic sensor 170A is a normal one of a fourth level (predetermined value) or less. In this state, it can be deduced that the calculated result of the bearing from the bearing calculation unit 154 based on the detected value of the intensity of the magnetism of the geomagnetic sensor 170A is correct.

(2) Fourth Level to Third Level (Geomagnetism Detection is Not Correct)

When the first housing 3 and second housing 4 approach each other from the spaced apart state to the facing direction, the geomagnetic sensor 170A begins to be influenced by the magnetic field of the magnet 190. When the detected value of geomagnetism of the geomagnetic sensor 170A reaches the third level over the fourth level (predetermined value), the calculated result of the bearing from the bearing calculation unit 154 based on the detected value of the geomagnetic sensor 170A is no longer correct.

Alternatively, if the detected value of the geomagnetism of the geomagnetic sensor 170A exceeds the fourth level and reaches the third level due to the influence of the external magnetic field other than the magnet 190, the calculated result of the bearing from the bearing calculation unit 154 based on the detected value of the geomagnetic sensor 170A is no longer correct.

In this case, the suppression of the report of bearing information is started. The user can calibrate the result according to need.

(3) Third Level to Second Level (Housing Facing State, Poor Geomagnetism Detection)

When the first housing 3 and second housing 4 are moved from the spaced apart state to a substantially facing state or completely facing state, the geomagnetic sensor 170A is further strongly affected by the magnetic field of the magnet 190. When the detected value of the intensity of the magnetism of the geomagnetic sensor 170A exceeds the third level and reaches the second level (threshold value), the calculated result of the bearing from the bearing calculation unit 154 based on the detected value of the intensity of magnetism of the geomagnetic sensor 170A is not correct. In this case, it can be deduced that the first housing 3 and second housing 4 approach the substantially facing state (first state of the housings).

Alternatively, when the detected value of the intensity of magnetism of the geomagnetic sensor 170A exceeds the third level and reaches the second level (threshold value) due to the influence of the external magnetic field other than the magnet 190, the calculated result of the bearing from the bearing calculation unit 154 based on the detected value of the geomagnetic sensor 170A is no longer correct.

In this case, the suppression of a report of the bearing information is suspended. The user can calibrate the results according to need.

(4) First Level or Higher (Strong External Magnetic Field)

If the detected value of the intensity of the magnetism of the three-dimensional geomagnetic sensor 170A greatly exceeds the second level (threshold value) meaning the facing state of the first housing 3 and second housing 4 and becomes the first level (prescribed value) or higher, it can be deduced that not only the geomagnetic sensor 170A, but also the entire mobile phone 1 is influenced by a very strong external magnetic field other than the magnet 190. In such a state where these are influenced by a very high external magnetic field, the mobile phone 1 may malfunction or the electronic circuits etc. of the mobile phone 1 may be damaged in some cases. In such a case, desirably the power switch unit 110 is turned off and the supply of power from the battery unit 111 is suspended.

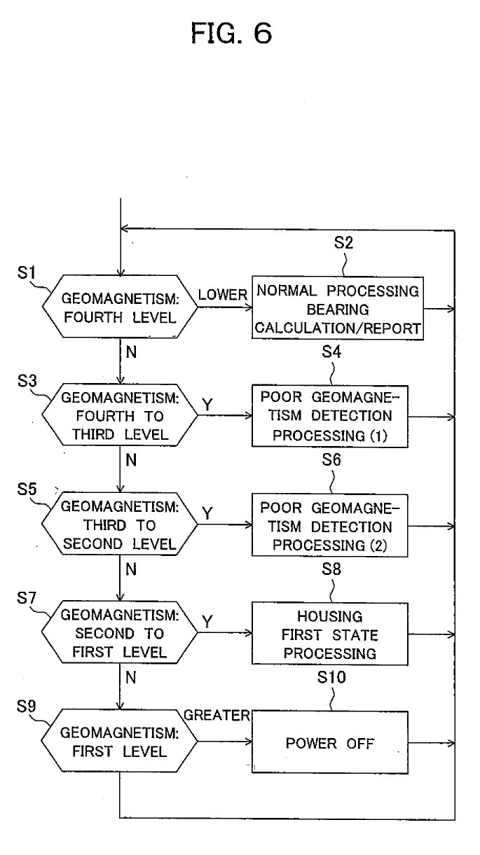

FIG. 6 is a flow chart showing the processing of the signal processing unit 150 in this example.

Step 1: Judgment of Fourth Level or Less

The external magnetism detection processing unit 160 (or general processing unit 152) monitors the detected value of the intensity of the magnetism of the three-dimensional geomagnetic sensor 170A and judges whether it is the fourth level or less.

Step 2: Calculation of Bearing and Report

When the detected value of the geomagnetic sensor 170A is the fourth level or less, the external magnetism detection processing unit 160 estimates that the detected value of the geomagnetic sensor 170A is normal and starts the bearing calculation unit 154.

The bearing calculation unit 154 calculates the bearing based on the detected value of the geomagnetic sensor 170A. The bearing information report unit 156 reports the result of that to, for example, the display unit 12. An example of the report was explained above.

Step 3: Judgment of Fourth to Third Level

The external magnetism detection processing unit 160 (or general processing unit 152) monitors the detected value of the geomagnetic sensor 170A and judges whether it is larger than the fourth level and not more than the third level.

Step 4: Poor Detection of Geomagnetism (1)

When the detected value of the geomagnetic sensor 170A is larger than the fourth level and not more than the third level, the external magnetism detection processing unit 160 estimates that the detected value of the geomagnetic sensor 170A is poor and starts the report suppression unit 158.

The report suppression unit 158 suppresses or suspends the report of the bearing by the bearing information report unit 156. An example of the suppression or suspension of the report by the report suppression unit 158 was explained above.

The user who learns of the suppression of the bearing report, calibrates the bearing according to need.

Step 5: Judgment of Third to Second Level

The external magnetism detection processing unit 160 (or general processing unit 152) monitors the detected value of the geomagnetic sensor 170A and judges whether it is larger than the third level and not more than the second level.

In this state, there is a possibility that the geomagnetic sensor 170A is influenced by the magnetic field of the magnet 190. It may also be influenced by another external magnetic field.

Step 6: Poor Detection of Geomagnetism (2)

When the detected value of the intensity of the geomagnetic sensor 170A is larger than the third level and not more than the second level, the external magnetism detection processing unit 160 estimates that the detected value of the intensity of the magnetism of the geomagnetic sensor 170A is poor and starts the report suppression unit 158. The report suppression unit 158 suppresses or suspends the report by the bearing information report unit 156 in the same way as that described above.

The user who learns of the suppression of the bearing report, calibrates the bearing according to need.

Step 7: Judgment of Second to First Level

The external magnetism detection processing unit 160 (or general processing unit 152) monitors the detected value of the geomagnetic sensor 170A and judges whether it is larger than the second level and not more than the first level.

Step 8: Judgment of First State of Housings

This state can be estimated as the first state of the housings where the first housing 3 and the second housing 4 face each other. Alternatively, there also exists a possibility that the geomagnetic sensor 170A is affected by a strong external magnetic field corresponding to the first state of the housings. However, it cannot be judged which of these states it is.

Therefore, the external magnetism detection processing unit 160 starts the general processing unit 152. The general processing unit 152 judges the first state of the housings when the first housing 3 and the second housing 4 face each other.

Further, the external magnetism detection processing unit 160 starts the report suppression unit 158 and suppresses or suspends the report by the bearing information report unit 156 in the same way as that described above. Naturally, the first housing 3 and the second housing 4 are in the closed state. Therefore, usually, the display unit 12 does not display anything.

Step 9: Case Larger than First Level

The external magnetism detection processing unit 160 (or general processing unit 152) monitors the detected value of the intensity of the magnetism of the geomagnetic sensor 170A and judges whether it is larger than the first level.

Step 10: Abnormality Processing

When the detected value of the geomagnetic sensor 170A exceeds the first level, the external magnetism detection processing unit 160, for example, starts the general processing unit 152, turns off the power switch unit 110, suspends the supply of electric power from the battery unit 111 to the electronic circuits in the mobile phone 1, and protects the mobile phone 1.

By using the three-dimensional geomagnetic sensor 170A illustrated in FIG. 4 for the detection of geomagnetism, the detection of magnetism of the magnet 190, and the detection of the external magnetic field, the various aspects explained above could be realized.

In particular, processing of the bearing considering the influence of the intensity of external magnetism upon the geomagnetic sensor 170 can be carried out. As a result, bearing information which is erroneous or has unclear reliability will not be reported to the user.

### Third Example of Arrangement of Geomagnetic Sensor, Magnetic Sensor, and Magnet

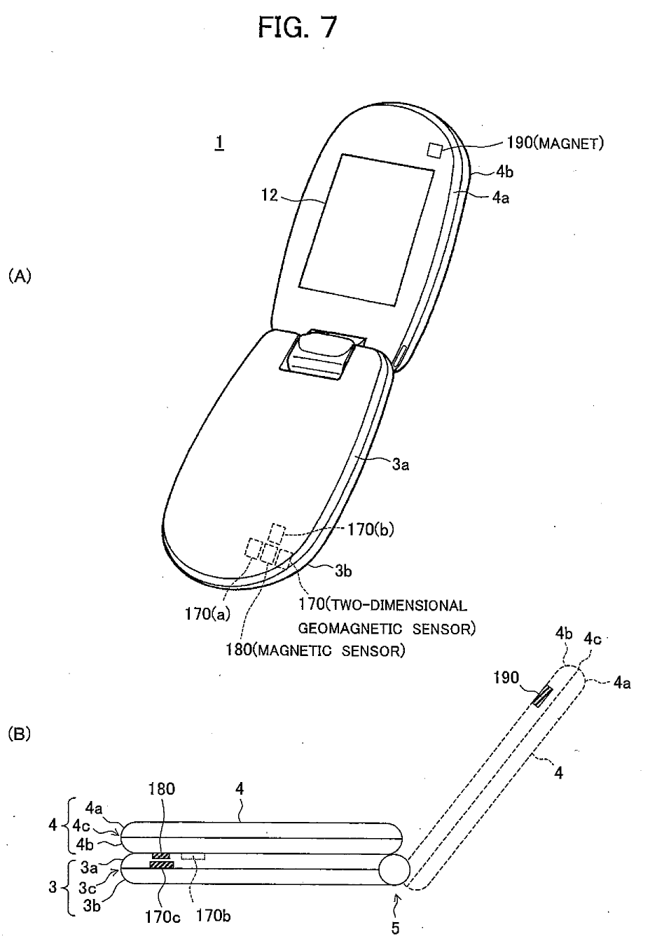

FIGS. 7(A) and 7(B) are diagrams corresponding to FIGS. 1(A) and 1(B) and illustrate a third example of arrangement of the two-dimensional geomagnetic sensor 170, magnetic sensor 180, and magnet 190.

For simplifying the illustration, only the geomagnetic sensor 170, magnetic sensor 180, and magnet 190 are illustrated.

The magnet 190 is a permanent magnet.

The third example of arrangement is characterized in that the two-dimensional geomagnetic sensor 170, magnetic sensor 180, and magnet 190 are arranged in the same way as the first example of arrangement, and further the two-dimensional geomagnetic sensor 170 is arranged in the vicinity of the magnetic sensor 180.

The reason for the arrangement of the geomagnetic sensor 170 in the vicinity of the magnetic sensor 180 is receiving the influence of the magnet 190 together with the magnetic sensor 180 and enabling differentiation as to whether the detected value of geomagnetism of the geomagnetic sensor 170 is influenced by the magnet 190 or by another external magnetic field.

For example, the magnetic sensor 180 is arranged on the back surface or front surface of the first housing upper portion 3a. The geomagnetic sensor 170 is arranged in the vicinity of this magnetic sensor 180, for example, (1) in the vicinity of the magnetic sensor 180 on the same plane as that for the magnetic sensor 180 illustrated as notations 170a and 170b or (2) in the first housing lower portion 3b in the lower portion of the magnetic sensor 180 illustrated as notation 170c.

The magnet 190 is arranged, in the same way as the first and second examples of arrangement, at the outer circumferential portion of the display unit 12 on the back surface or front surface of the second housing lower portion 4b.

The magnetic sensor 180 and the magnet 190 are located at positions where these face each other when the first housing 3 and the second housing 4 face each other in the same way as the case of the first arrangement.

When the magnetic sensor 180 is influenced by the magnetic field of the magnet 190, the geomagnetic sensor 170 arranged in the vicinity of the magnetic sensor 180 is influenced by the magnetic field of the magnet 190 as well.

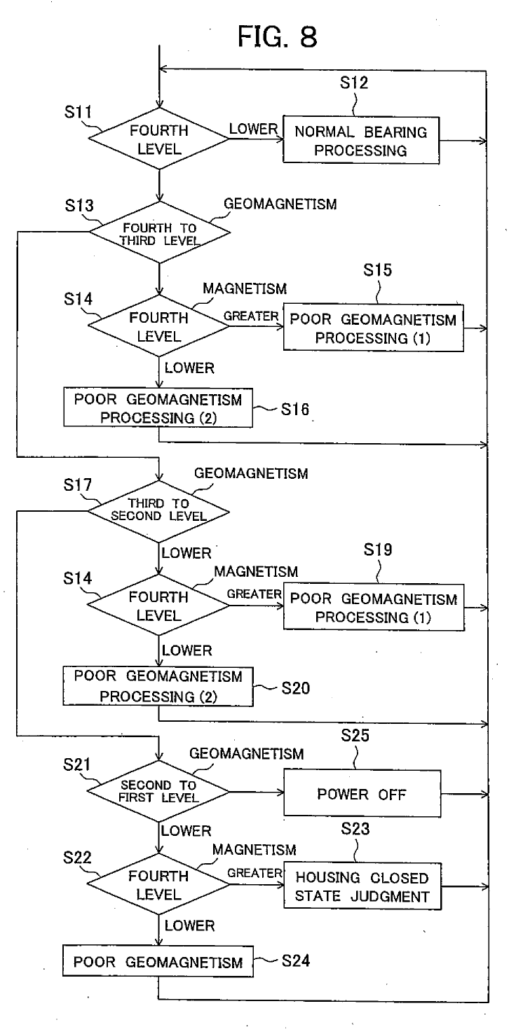

FIG. 8 is a flow chart showing the processing of the signal processing unit 150 in this example.

Step 11: Judgment of Fourth Level or Less

The external magnetism detection processing unit 160 (or general processing unit 152) monitors the detected value of the geomagnetic sensor 170, and judges whether it is the fourth level or less.

Step 12: Calculation of Bearing and Report

When the detected value of the geomagnetic sensor 170 is not more than the fourth level, the external magnetism detection processing unit 160 estimates that the detected value of geomagnetic sensor 170 is normal and starts the bearing calculation unit 154.

The bearing calculation unit 154 calculates the bearing based on the detected value of the geomagnetic sensor 170, and the bearing information report unit 156 reports the result of that to, for example, the display unit 12. An example of the report was explained above.

This processing is the same as the processing of steps 1 and 2.

Steps 13 to 14: Judgment of Fourth to Third Level

The external magnetism detection processing unit 160 (or general processing unit 152) monitors the detected value of the geomagnetic sensor 170, judges whether it is larger than the fourth level and not more than the third level, and, when it is within this range, further judges whether the detected value of the magnetic sensor 180 is the fourth level or less.

Step 15: Poor Geomagnetism Detection (1)

When the detected value of the geomagnetic sensor 170 is larger than the fourth level and not more than the third level and when the detected value of the magnetic sensor 180 is the fourth level or more and not more than the third level in the same way as the geomagnetic sensor 170, the external magnetism detection processing unit 160 estimates that these detected values are due to the influence of the magnetic field by the magnet 190.

The external magnetism detection processing unit 160 starts the report suppression unit 158. The report suppression unit 158, for example, suppresses or suspends the report of the bearing information report unit 156 and further preferably reports a message indicating poor detection of the geomagnetic sensor 170 caused by the magnet 190 to the display unit 12.

Step 16: Poor Geomagnetism Detection (2)

When the detected value of the geomagnetic sensor 170 is larger than the fourth level and not more than the third level and when the detected value of the magnetic sensor 180 is the fourth level or less, the external magnetism detection processing unit 160 estimates that there is no influence of the magnetic field by the magnet 190 and that the geomagnetic sensor 170 has been affected by another external magnetic field.

The external magnetism detection processing unit 160 starts the report suppression unit 158. The report suppression unit 158, for example, suppresses or suspends the report of the bearing information report unit 156 and further preferably, for example, reports a message indicating the poor detection of the geomagnetic sensor 170 caused by the external magnetic field to the display unit 12.

By viewing the result, the user can calibrate the bearing. Namely, the user of the mobile phone 1 can avoid the situation of poor geomagnetism detection by moving to a place not influenced by an external magnetic field.

Steps 17 to 18: Judgment of Third to Second Level

The external magnetism detection processing unit 160 (or general processing unit 152) monitors the detected value of the geomagnetic sensor 170, judges whether it is larger than the third level and not more than the second level, and, when it is within this range, further judges whether the detected value of the magnetic sensor 180 is the fourth level or less.

Step 19: Poor Geomagnetism Detection (1)

When the detected value of the geomagnetic sensor 170 is larger than the third level and not more than the second level and when the detected value of the magnetic sensor 180 is larger than the third level and not more than the second level, in the same way as the geomagnetic sensor 170, the external magnetism detection processing unit 160 estimates that these are due to the influence of the magnetic field from the magnet 190.

The external magnetism detection processing unit 160 starts the report suppression unit 158. The report suppression unit 158, for example, suppresses or suspends the report of the bearing information report unit 156 and further preferably reports a message indicating poor detection of the geomagnetic sensor 170 caused by the magnet 190 to the display unit 12.

Step 20: Poor Geomagnetism Detection (2)

When the detected value of the geomagnetic sensor 170 is larger than the fourth level and not more than the third level and when the detected value of the magnetic sensor 180 is the fourth level or less, the external magnetism detection processing unit 160 estimates that there is no influence of the magnetic field by the magnet 190 and that the geomagnetic sensor 170 has been affected by another external magnetic field.

The external magnetism detection processing unit 160 starts the report suppression unit 158. The report suppression unit 158, for example, suppresses or suspends the report of the bearing information report unit 156 and further preferably, for example, reports a message indicating the poor detection of the geomagnetic sensor 170 caused by the external magnetic field to the display unit 12.

In this case as well, by viewing the results, the user can calibrate the bearing. Namely, the user of the mobile phone 1 can avoid the situation of poor geomagnetism detection by moving to a place not influenced by an external magnetic field.

Steps 21 to 22: Judgment of Second to First Level

The external magnetism detection processing unit 160 (or general processing unit 152) monitors the detected value of the geomagnetic sensor 170, judges whether it is larger than the second level and not more than the first level, and, when it is within this range, further judges whether the detected value of the magnetic sensor 180 is the fourth level or less.

Step 23: Judgment of Closed State of Housings

When the detected value of the geomagnetic sensor 170 is larger than the second level and not more than the first level and when the detected value of the magnetic sensor 180 is larger than the second level and not more than the first level in the same way as the geomagnetic sensor 170, the external magnetism detection processing unit 160 estimates the state is one where the first housing 3 and the second housing 4 face each other.

The external magnetism detection processing unit 160 starts the general processing unit 152. The general processing unit 152 judges whether the first housing 3 and the second housing 4 are in the first state, that is, the first housing 3 and the second housing 4 face each other.

The external magnetism detection processing unit 160 starts the report suppression unit 158. The report suppression unit 158, for example, suppresses or suspends the report of the bearing information report unit 156.

Step 24: Poor Geomagnetism Detection (2)

When the detected value of the geomagnetic sensor 170 is larger than the second level and not more than the first level and when the detected value of the magnetic sensor 180 is the fourth level or less, the external magnetism detection processing unit 160 estimates that there is no influence of the magnetic field by the magnet 190 and that the geomagnetic sensor 170 has been affected by another external magnetic field.

The external magnetism detection processing unit 160 starts the report suppression unit 158. The report suppression unit 158, for example, suppresses or suspends the report of the bearing information report unit 156 and further preferably, for example, reports a message indicating poor detection of the geomagnetic sensor 170 caused by the external magnetic field to the display unit 12.

In this case as well, the user of the mobile phone 1 can avoid the situation of poor geomagnetism detection by moving to a place not influenced by an external magnetic field.

Step 25: First Level or More

The external magnetism detection processing unit 160 (or general processing unit 152) monitors the detected value of the geomagnetic sensor 170. When it is larger than the first level, the external magnetism detection processing unit 160, for example, starts the general processing unit 152, turns off the power source switch unit 110 to suspend the supply of electric power from the battery unit 111 to the electronic circuit in the mobile phone 1, and thereby protects the mobile phone 1.

By arranging the geomagnetic sensor 170 in the vicinity of the magnetic sensor 180 in this way, it can be differentiated whether the detected value of the geomagnetism of the geomagnetic sensor 170 is influenced by the magnet 190 or by another external magnetic field.

In particular, according to the present embodiment, bearing processing considering the influence of the intensity of external magnetism upon the geomagnetic sensor 170 can be carried out. As a result, erroneous bearing information or bearing information having unclear reliability will not be reported to the user.

### Fourth Example of Arrangement of Geomagnetic Sensor, Magnetic Sensor, and Magnet

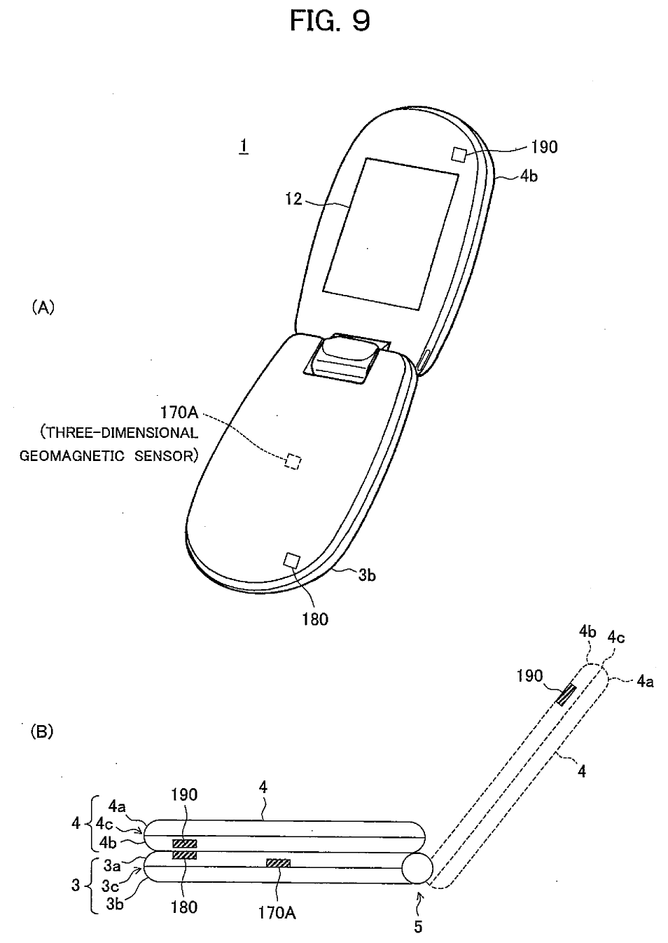

FIGS. 9(A) and 9(B) are diagrams corresponding to FIGS. 1(A) and 1(B) and illustrating a fourth example of arrangement of the three-dimensional geomagnetic sensor 170A, magnetic sensor 180, and magnet 190.

For simplifying the illustration, only the three-dimensional geomagnetic sensor 170A, magnetic sensor 180, and magnet 190 are illustrated.

In the fourth example of arrangement, unlike the first example of arrangement, the three-dimensional geomagnetic sensor 170A is arranged at the center of the first housing lower portion 3b in the same way as FIG. 3(A).

The three-dimensional geomagnetic sensor 170A is, as explained in the second example of arrangement, configured to be capable of detecting intensities of the magnet 190 and other magnetism as well. The three-dimensional geomagnetic sensor 170A is used for both of the detection of geomagnetism for the bearing calculation and the intensity of the magnetism.

In the present example, the magnetic sensor 180 and the magnet 190 are arranged for detecting the open/closed state of the first housing 3 and second housing 4 as explained above. The processing for judgment of the state of these housings is carried out by the method explained above in, for example, the general processing unit 152.

In this example, the external magnetism detection processing unit 160 uses the detected value of the intensity of the magnetism of the three-dimensional geomagnetic sensor 170A to perform a judgment in the same way as the second example of arrangement. However, it does not consider the influence of the magnet 190, therefore the external magnetism detection processing unit 160 refers to only the result of the judgment of the open/closed state of the housings by the general processing unit 152 by using the magnetic sensor 180 and the magnet 190, for example, whether the first housing 3 and the second housing 4 face each other (in the first state) or are in another state.

Naturally, the geomagnetism detected value in the two-dimensional direction of the three-dimensional geomagnetic sensor 170A is used for the calculation of the bearing in the bearing calculation unit 154.

By using the three-dimensional geomagnetic sensor 170A, the external magnetism detection processing unit 160 can performing bearing processing by considering the influence of the external magnetic field with reference to the result of judgment of the housing state by the general processing unit 152 using the magnetic sensor 180 and the magnet 190.

In particular, the bearing processing considering the influence of the intensity of the external magnetism upon the geomagnetic sensor 170A can be carried out. As a result, erroneous bearing information or bearing information having unclear reliability will not be reported to the user.

In the first to fourth examples of arrangement explained above, the geomagnetic sensor 170, three-dimensional geomagnetic sensor 170A, magnetic sensor 180, and magnet 190 can be suitably arranged, for example, arranged in the first housing upper portion 3a, arranged in the first housing lower portion 3b, arranged in the second housing upper portion 4a, or arranged in the second housing lower portion 4b, so long as the positional relationships explained above are considered. The arrangement may be reversed as well, for example, the magnet 190 arranged in the first housing upper portion 3a, and the magnetic sensor 180 and/or geomagnetic sensor 170 arranged in the second housing upper portion 4a or second housing lower portion 4b.

### Second Embodiment

In the first embodiment, a flip-open type mobile electronic apparatus was explained, but the same processing as that described above can be carried out for a straight type mobile phone 1A as well.

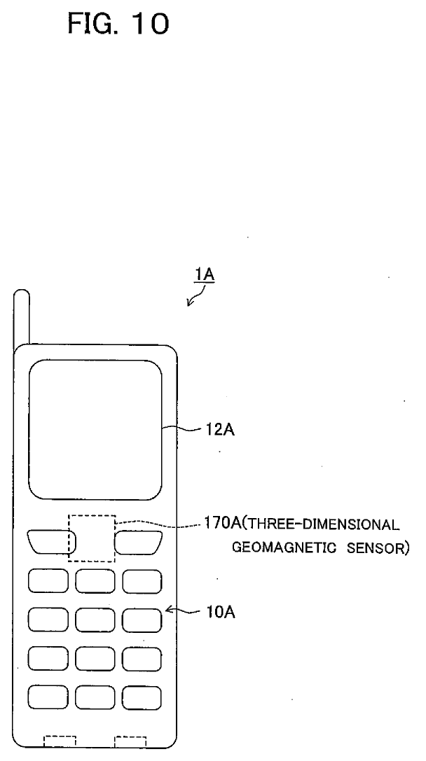

FIG. 10 is a view of the outer appearance of the straight type mobile phone.

The straight type mobile phone 1A has a key input unit 10A and a display unit 12A.

In the straight type mobile phone 1A as well, the constitution becomes the same as that of the signal processing unit 100 illustrated in FIG. 2 except for the magnetic sensor 180 and the magnet 190 for detecting the open/closed state of the housings and except for the processing for detecting the open/closed state of the housing by the general processing unit 152.

### Fifth Example of Arrangement

In FIG. 10, the three-dimensional geomagnetic sensor 170A is held in the housing.

In the fifth example of arrangement, as explained with reference to the second example of arrangement and the fourth example of arrangement, the three-dimensional geomagnetic sensor 170A is configured to be capable of detecting the intensity of magnetism other than the detection of the geomagnetism on a two-dimensional plane.

In the straight type mobile phone 1A, it is not necessary to consider the processing for judging the open/closed state of the housings and the influence of the magnetism caused by the magnet 190. Accordingly, for FIG. 10, the three-dimensional geomagnetic sensor 170A may be arranged at the center of the first housing lower portion 3b, and processing the same as that in the case where the influence of the magnet 190 is eliminated may be carried out.

Namely, the external magnetism detection processing unit 160 receives as input the detected value of the intensity of the magnetism of the three-dimensional geomagnetic sensor 170A, and as explained above with reference to FIG. 5, performs the same processing as the processing explained with reference to FIG. 6 in accordance with to which level the detected value of the intensity corresponds.

In this way, by using the three-dimensional geomagnetic sensor 170A, in the straight type mobile phone 1A as well, bearing processing considering the influence of the intensity of the external magnetism can be carried out. As a result, erroneous bearing information or bearing information having unclear reliability will not be reported to the user.

### Sixth Example of Arrangement

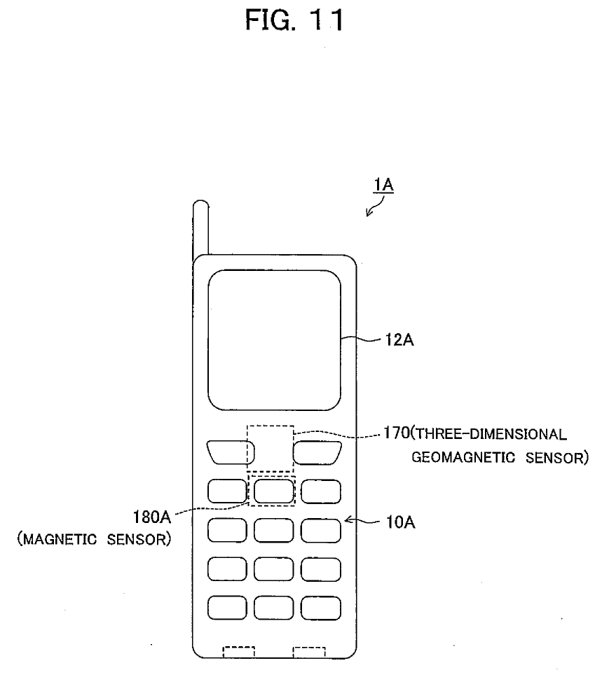

In a sixth example of arrangement illustrated in FIG. 11, a two-dimensional geomagnetic sensor 170 and a magnetic sensor 180A are arranged in the vicinity of the geomagnetic sensor 170.

As the magnetic sensor 180A, for example, use can be made of an MR sensor.

The two-dimensional geomagnetic sensor 170, unlike the three-dimensional geomagnetic sensor 170A, detects the geomagnetism in the two-dimensional direction, but cannot detect the intensity of the magnetism. Therefore, the magnetic sensor 180A is arranged in the vicinity of the geomagnetic sensor 170, and the influence of the external magnetic field exerting influence upon the geomagnetic sensor 170 is detected by the magnetic sensor 180A.

The external magnetism detection processing unit 160 receives as input the detected value of the intensity of the magnetism of the magnetic sensor 180A and, as explained above with reference to FIG. 5, performs the same processing as the processing explained with reference to FIG. 6 in accordance with to which level the detected value of the intensity corresponds.

In this way, by using the magnetic sensor 180A, in the straight type mobile phone 1A as well, bearing processing considering the influence of the intensity of the external magnetism can be carried out. As a result, erroneous bearing information or bearing information having unclear reliability will not be reported to the user.

As explained above, the mobile phones 1 and 1A in the present embodiment are configured so that, when it is judged that the magnetisms given to the geomagnetic sensors 170 and 170A are not proper, the report of the bearing information based on the bearings detected by these geomagnetic sensors is suppressed, and the user can be made to recognize that external magnetism is given to the geomagnetic sensors. Further, by suppressing the report of the bearing information, the report of erroneous bearing information can be avoided. In particular, when suppressing the bearing information, it is possible to suspend the report of the bearing information, whereby it is possible to draw the attention of the user and possible to more effectively recognize external magnetism and avoid erroneous reports. Further, it would be more effective if employing a configuration reporting warning information in place of the bearing information or in addition to the bearing information in the case of suppressing the report of the bearing information. For example, when giving a warning, content prompting calibration may be warned (reported) together.

Further, when arranging the magnetic sensor 180 in the vicinity of the geomagnetic sensors 170 and 170A, by arranging the magnetic sensor 180 on the outer circumferential side (lower side or width direction end side of the first housing 3) of the terminal (for example, mobile phone) more than the geomagnetic sensors 170 and 170A, the external magnetisms exerting influence upon the geomagnetic sensors 170 and 170A can be preferably detected by the magnetic sensor 180. Further, by employing a configuration arranging the magnetic sensor 180 at the location nearer the magnet 190 than the geomagnetic sensors 170 and 170A, the magnetism from the magnet 190 and external magnetisms exerting an influence upon the geomagnetic sensors 170 and 170A can be detected with a good response.

The invention is not limited to the above examples when being worked. Various modifications can be employed.

For example, in the embodiments explained above, it was stated that the report suppression unit 158 and the external magnetism detection processing unit 160 did not function in the configuration illustrated in FIGS. 3(A) and 3(B). However, it is also possible to configure these as follows. For example, when the magnetism detected by the magnetic sensor 180 becomes magnetism corresponding to the magnet 190 or greater, this means a state where an external magnetic field other than the magnet 190 is given to the magnetic sensor 180 by, for example, the approach of a strong magnet other than the magnet 190 to the vicinity of the magnetic sensor 180 of the mobile phone 1. There is a possibility that the external magnetic field given to the magnetic sensor 180 exerts an influence upon the geomagnetic sensors 170 and 170A or mobile phone 1. Accordingly, in this configuration as well, when the magnetic sensor 180 detects that an external magnetic field other than the magnet 190 is given, it is judged that this external magnetic field may exert an influence upon the geomagnetic sensors 170 and 170A as well. As explained above, the suppression of the report of the bearing information based on detected values of the geomagnetic sensors 170 and 170A may be started as well. In this case, the user can be made recognize that there is a possibility that the geomagnetic sensors 170 and 170A are being affected by an external magnetic field etc.

Note that the entire content of Japanese Patent Application No. 2006-051377 (filed on Feb. 27, 2006) is incorporated by reference in the Description of this application.

1. A mobile electronic apparatus comprising:
a housing;
a geomagnetic sensor provided in the housing and detecting geomagnetism;
a bearing calculation unit configured to calculate a geographical bearing based on a detected value by the geomagnetic sensor;
a bearing information report unit configured to report bearing information based on the bearing calculated by the bearing calculation unit;
an external magnetism detection unit configured to detect an external magnetism with respect to the geomagnetic sensor; and
a report suppression unit configured to suppress the report of bearing information by the bearing information report unit when the detected value of the external magnetism by the external magnetism detection unit becomes a predetermined value or greater.

2. A mobile electronic apparatus as set forth in claim 1, wherein:
the geomagnetic sensor is configured to be capable of detecting an intensity of magnetism, and
the external magnetism detection unit detects the external magnetism in accordance with an intensity of the magnetism detected by the geomagnetic sensor.

3. A mobile electronic apparatus as set forth in claim 1, wherein:
the external magnetism detection unit has a magnetic sensor arranged in the vicinity of the geomagnetic sensor and capable of detecting the intensity of the magnetism.

4. A mobile electronic apparatus as set forth in any one of claims 1 to 3, wherein:
the report suppression unit suspends the report of the bearing information when the detected value from the external magnetism detection unit becomes a predetermined value or greater.

5. A mobile electronic apparatus as set forth in claim 4, wherein:
the report suppression unit suppresses the report information by raising an alarm when the detected value from the external magnetism detection unit becomes a predetermined value or greater.

6. A mobile electronic apparatus as set forth in claim 5, wherein:
the report suppression unit turns off the power of the mobile electronic apparatus when the detected value from the external magnetism detection unit becomes at least a prescribed value larger than the predetermined value.

7. A mobile electronic apparatus as set forth in claim 6, wherein:
the housing has a first housing, a second housing, and a connecting portion configured to connect the first housing and the second housing, and is configured so that the first housing and the second housing can be opened and closed by the connecting portion between a first state where these face each other and a second state where these do not face each other,
the first housing is configured arranging the geomagnetic sensor at a location where it faces the second housing in the first state,
the second housing is configured arranging a magnet at a location where it faces the geomagnetic sensor in the first state,
the geomagnetic sensor is configured to be capable of detecting the intensity of the magnetism,
the external magnetism detection unit judges that the housings are in the first state when the geomagnetic sensor detects a magnetism of at least a threshold value set in accordance with the magnetic field generated by the magnet, and
the report suppression unit suppresses the report of the bearing information when detecting that the magnetism detected value of the geomagnetic sensor becomes at least a predetermined value set smaller than the threshold value.

8. A mobile electronic apparatus as set forth in claim 7, wherein:
the housing has a first housing, a second housing, and a connecting portion configured to connect the first housing and the second housing, and is configured so that the first housing and the second housing can be opened and closed by the connecting portion between a first state where they face each other and a second state where they do not face each other,
the first housing is configured arranging the geomagnetic sensor at a location where it faces the second housing in the first state and a magnetic sensor arranged in the vicinity of the geomagnetic sensor and capable of detecting the intensity of the magnetism,
the second housing is configured arranging a magnet at a location where it faces the geomagnetic sensor in the first state,
the external magnetism detection unit judges that the housings are in the first state when the magnetic sensor detects a magnetism of at least a threshold value set in accordance with the magnetic field generated by the magnet, and
the report suppression unit suppresses the report of the bearing information when a magnetism of not less than a predetermined value set smaller than the threshold value is detected by the geomagnetic sensor.

9. A mobile electronic apparatus as set forth in claim 8, wherein:
the magnetic sensor is arranged on the second housing side with respect to the geomagnetic sensor when the housings are in the first state.

10. A method for processing a bearing of a mobile electronic apparatus having a housing and a geomagnetic sensor provided in the housing and detecting geomagnetism, comprising:
a bearing calculation step of calculating a geographical bearing based on the detected value of the geomagnetic sensor;
a bearing information reporting step of reporting information based on the bearing calculated at the bearing calculation step;
an external magnetism detection step of detecting an external magnetism with respect to the geomagnetic sensor; and
a report suppression step of suppressing the report of bearing information in the bearing information reporting step when the value detected in the external magnetism detection step becomes a predetermined value or greater.
